(19) United States
(12) Patent Application Publication
(10) Pub. No.: US 2023/0048739 A1
(43) Pub. Date: Feb. 16, 2023

(54) POSITIONING IN A WIRELESS COMMUNICATION NETWORK

(71) Applicant: Sony Group Corporation, Tokyo (JP)

(72) Inventors: Erik BENGTSSON, Eslöv (SE); Anders BERGGREN, Lund (SE); Basuki PRIYANTO, Lund (SE)

(21) Appl. No.: 17/795,982

(22) PCT Filed: Feb. 12, 2021
(86) PCT No.: PCT/EP2021/053447

§ 371 Date: Jul. 28, 2022

(30) Foreign Application Priority Data
Feb. 13, 2020 (SE) 2030049-7

(51) Int. Cl. H04W 64/00; H04W 16/28; G01S 5/02

(52) U.S. Cl. CPC H04W 64/00; H04W 16/28; G01S 5/02521

(57) ABSTRACT

A method for operating a network node (100) in a wireless communication network is provided. The method comprises transmitting at least one beamformed signal (20-27). Each one of the at least one beamformed signal (20-27) is indicative of a respective positioning information. The respective positioning information is indicative of a respective virtual reference point (40-47) which is offset from a position of a transmit point (50) of the wireless communication network used for transmitting the at least one beamformed signal (20-27). The beamformed signal (20-27) is suitable for enabling a positioning measurement of a wireless communication device (200).

### FIELD OF THE INVENTION

Various examples relate to methods for operating devices in a wireless communication network. In particular, various examples relate to methods for operating a network node for transmitting signals suitable for enabling a positioning estimate of a wireless communication device in the wireless communication network. Furthermore, various examples relate to methods for operating a wireless communication device for estimating its position based on signals received from a network node of the wireless communication network. The present invention relates furthermore to devices implementing the methods.

### BACKGROUND OF THE INVENTION

A location of a device, in particular a wireless communication device, for example a smart phone, a tablet PC, an Internet of Things (IoT) device or any other type of terminal device, is an important and often required information of applications used in connection with the device. Accurate positioning may be achieved by a combination of multiple technologies, including for example GNSS (Global Navigation Satellite System) based solutions, providing accurate positioning in outdoor scenarios, radio technologies, for example Third Generation Partnership (3GPP) Long Term Evolution (LTE) networks offering multiple design options to locate a user, IEEE Wi-Fi networks or terrestrial beacon systems, and IMU (Inertial Measurement Units) or sensors, for example accelerometers, gyroscopes, magnetometers or atmospheric pressure sensors.

In particular, the 3GPP NR radio technology may provide enhanced location capabilities. In 3GPP NR, wireless communication may be operated in two sets of frequencies, namely FR1 for communication using frequencies below 6 GHz and FR2 for communication using frequencies in a range of for example 24.25 GHz to 52.6 GHz, or in even higher frequencies than FR2.

Network nodes, in particular network notes according to 3GPP NR, may utilize multiple send and receive antennas. For example, a network node may include a large number of antennas, e.g. antenna elements or antenna panels, that are operated fully coherently and adaptively. The network node may include for example several tens or even in excess of one hundred antennas with associated transceiver circuitry. The multiple antennas allow radio energy in particular at FR2 frequencies to be spatially focused in transmissions as well as a directional sensitive reception, which improve spectral efficiency and radiated energy efficiency. The large number of antennas may be utilized for beamforming (BF). BF relies on phasing the antennas in order to obtain a beam in a certain direction. Multiple beams or signals having different radiation directions may be utilized.

BF may be used in order to compensate high path loss in FR2, in particular at the network nodes, for example a gNB. Further, the utilization of large antenna arrays and BF may provide improved positioning accuracy.

BF may be utilized to support a device-based downlink-only positioning. This means that the device shall be able to determine its position based on downlink signals from the network only, i.e. without interaction from the network. The device receives only downlink signals, and does not need to communicate with the network in an uplink direction for positioning to complete the positioning. This may reduce communication between the network and the device and may further enable a fast positioning at the device.

For power consumption reduction and/or reducing latency, a wireless communication device may perform positioning estimation utilizing signals received from one or multiple network nodes. Based on these signals, the device may determine its position relative to the network nodes. However, this may include that the device needs to obtain the (absolute) position of the network node(s) for determining its absolute position.

Thus, the position of each network node is revealed in an absolute or relative manner. In either case, a device may easily obtain the position of some or all network nodes from which it receives the beamformed positioning signals. This may be unwanted by a provider of the wireless communication network.

### SUMMARY OF THE INVENTION

In view of the above, there is a need in the art for enhancing positioning technologies, in particular positioning technologies which rely on downlink communication only.

According to the present invention, this object is achieved by the features of the independent claims. The dependent claims define embodiments of the invention.

A downlink positioning signal provided by the network may include (e.g., encode) spatial direction information, for example azimuth and/or elevation and/or beamwidth. Alternatively or additionally, the downlink positioning signal may include a reference location indicating the origin of the downlink positioning signal. Alternatively or additionally, the downlink positioning signal may comprise a timing information enabling the receiving device to determine the distance to the origin of the downlink positioning signal based on a time of flight of the downlink positioning signal from the origin to the device. For example, the receiver may estimate a CIR (channel impulse response) with relative timing (i.e., time signature). The absolute timing of the received signal may depend on a synchronization of the clock of the device with a network timing, e.g. frame boundaries. To estimate the absolute position of the device, the device may receive such signals from a plurality of network nodes (e.g. three) and then use the relative time profiles and the positions from each of the network nodes to determine its position. The clocks of the multiple network nodes may need to be absolutely synchronized which may sometimes be difficult to achieve, e.g., for multiple base stations in a radio-access network of a cellular network.

In other examples, the spatial direction information, the reference location and/or a timing reference information may be provided by the network to the device in configuration information. For example, the configuration information may be provided to the device when registering at a cell or after registration, e.g., when operating in a connected mode (e.g., 3GPP RRC_Connected) in which a data connection between the device and the network is setup, or even in a disconnected mode (e.g., 3GPP RRC_Idle or RRC_Inactive), e.g., using broadcasted information. The configuration information may comprise information concerning a currently serving cell and neighboring cells and may be included in assistance information, for example OTDOA (observe time difference of arrival) reference cell assistance information and/or OTDOA neighbor cell assistance information.

Even the positioning signal may identify, for example implicitly based on resources in which the PRS is transmitted, the configuration information.

As a general rule, the device may estimate its position based on the positioning reference signal and the configuration information.

As a general rule, the downlink positioning signal may comprise a positioning reference signal (PRS). As a general rule, a PRS may have some similarities with cell-specific reference signals as defined in 3GPP Release 8. As a general rule, a PRS may be a pseudo-random QPSK sequence. The PRS may be mapped in diagonal patterns in a time-frequency resource grid, e.g., with shifts in frequency and time to avoid collision with cell-specific reference signals and an overlap with the control channels (PDCCH). PRS can be defined by bandwidth , offset, duration , and periodicity. The PRS bandwidth may be smaller than the system bandwidth.

In general, a single beam with direction information (azimuth and/or elevation), origin and a timing information can be used to estimate the position of the device.

FIG. 1 illustrates a positioning technology using beamformed positioning signals. A network node 100 comprises an antenna array 50 configured to transmit beamformed signals 20 to 27 in different directions 30 to 37. The antenna array 50 may comprise a plurality of antenna elements for establishing the transmission of the beamformed signals 20 to 27. The antenna array 50 may be located nearby the network node 100 or spaced apart from the network node 100. Each beamformed signal 20 to 27 includes direction information indicating a direction 30-37 of the beam and a position information indicating the origin from which the beamformed signals 20 to 27 were transmitted. The origin corresponds essentially to the position of the antenna array 50. The position information indicating the origin/antenna array 50 may comprise an absolute global position or a relative position with respect to a predefined global position or a predefined reference system. Each beamformed signal 20 to 27 includes a timing information which enables a receiving device 200 to determine a relative distance between the device 200 and the origin 50 based on the time of flight of the received beamformed signal 20 to 27. In the example shown in FIG. 1, the device 200 is located in a sector covered by beamformed signal 21. Upon receiving the beamformed signal 21, the device 200 may determine its position with respect to the origin 50 based on the direction information and timing information included in the beamformed signal 21. In connection with the position information concerning the origin 50, the device 200 may determine its absolute global position or its relative position with respect to a reference system.

For example, in order to save information bits related to the origin, only delta information may be needed. The absolute position associated with the origin of a beam may not be included in the broadcasted positioning information and/or configuration information but rather a relative position, referring to an absolute reference position.

The accuracy of the positioning may depend on the beamwidth of the beam transmitted from the network node and by a timing accuracy, for example an accuracy of a synchronization of reference clocks in the device and the network node. For example, when connected, a device can synchronize a time offset from a time-advance (TA) information shared by the network node. However, this may not provide sufficient accuracy for positioning purpose. Therefore a round-trip-time (RTT) may be used but this involves both downlink (DL) and uplink (UL) transmissions.

For increasing positioning accuracy, the device may utilize multiple such beams from multiple network nodes.

According to various examples, methods for a network node and a device are provided for enabling the device to obtain and calculate a position of the device. The methods may rely on signals transmitted in a downlink direction only, i.e. signals transmitted from the network node to the device. However, the methods may also be used in connection with positioning technologies including uplink communication.

The device may comprise for example a terminal device like a mobile telephone, in particular a so-called smart phone, a tablet PC or an Internet of Things (IoT) device. However, the method is not restricted to terminal devices, but may also be used in connection with a base station, relay device or access device of a wireless communication network. The wireless communication network may comprise for example a cellular Long Term Evolution (LTE) system or 5G New Radio (NR) system as defined by 3GPP. The wireless communication network provides a wireless communication between the device and a network node of the wireless communication network. The network node may comprise for example a base station or access device of the wireless communication network, for example an eNB in LTE systems or a gNB in 5G NR systems.

In general, for a RSTD (reference signal time difference) based measurement to obtain and calculate a positioning, based on a downlink time difference of arrival (DL-TDOA) principle, a reference point (origin) of a downlink positioning reference signal (DL-PRS) transmission needs to be known. Further, a time stamp (i.e. when the DL-PRS was transmitted) or a time information enabling the receiving device to estimate the travel time from the point of origin to the device may be needed. Based on a plurality of DL-PRS from different origins may be combined to estimate the position of the device, for example by use of multi-lateration (e.g. trilateration). In case the network node is capable of transmitting the DL-PRS as a beamformed signal in the certain direction, positioning accuracy may be increased or a positioning may be based on a DL-PRS from single network node only. Hence, direction information indicating a direction from which a beamformed positioning signal is coming, may additionally be shared with the receiving device.

To avoid the network node to reveal its position, according to various examples, the network node may use an arbitrary position along the beam direction as a virtual origin of that beam. This may implicate that each beam will have an individual virtual origin position. The time stamp may be adjusted according to the distance between the actual origin of the transmit antenna and the virtual position.

As a result, from an algorithm perspective, the receiving device may transparently estimate its position based on the virtual origin position of the beam and the adjusted time information. The virtual origin position may be arbitrarily selected by the network node along a direction of the beam. A limitation of the virtual origin position may be set by a time window where the reference signal needs to be transmitted. For example, if the virtual origin position is too far away it will not hit the measurement window at the device side.

According to various examples, a method for operating a network node in a wireless communication network is provided. According to the method, at least one beamformed signal is transmitted. A beamformed signal may comprise a radio frequency signal which is transmitted from an antenna array of the network node and propagates essentially in a predefined direction only. For example, the beamformed signal may essentially propagate in a predefined direction with a predefined angle of radiation in a horizontal and vertical direction. Thus, the beamformed signal essentially can be received in a certain sector in an environment of the network node. It is to be understood that the antenna array must not be directly arranged at or near the network node, but may be arranged spaced apart from the network node such that the origin of the beamformed signal is not the network node itself, but the antenna array from which the beamformed signal is transmitted. The antenna array may be configured to transmit a plurality of beamformed signals in different directions, simultaneously or subsequently. The antenna array may be configured such that a predefined area in the environment of the antenna array may be covered by the plurality of beamformed signals. Each beamformed signal may have an angle of radiation of the few degrees, for example 5° to 20° in horizontal and/or vertical direction. At high frequencies, such as in FR2, the beamformed signal is typically a narrow beam transmission in order to obtain high antenna gain. At lower frequencies, such as FR1, it is typically realized with a sector antenna and results in a wider beam. The beamformed signal may comprise a reference signal, in particular a positioning reference signal (PRS) transmitted in a downlink (DL) direction from the network node to a device.

Each one of the at least one beamformed signal is indicative of a respective positioning information. The respective positioning information is indicative of a respective virtual reference point which is offset from a position of a corresponding (real or true) transmit point of the wireless communication network used for transmitting the at least one beamformed signal. A transmit point can be generally implemented by a 3GPP Transmit/Receive Point (TRP) or a base station or another access node. The (real) transmit point may be considered as the point from which the beamformed signal is actually transmitted, for example the location where the antenna array is located. The transmit point is also designated as Transmission Point TP. In other words, the positioning information indicated in a specific beamformed signal may indicate a position which does not correspond to the real position from which the beamformed signal has been transmitted. Thus, a position of the network node and/or the assigned antenna array cannot easily be obtained from the beamformed signal. Only the virtual reference point is disclosed to the device which may perform a positioning based on the beamformed signal. Nevertheless, as will be explained in more detail in the following, the beamformed signal is still suitable for enabling a positioning measurement of the device.

As a general rule, the offset between the virtual reference point and the transmit point may be larger than a minimum predetermined offset. For instance, the offset may be larger than 5 m or 100 m. As a general rule, the offset may be larger than a positioning accuracy of the positioning that is based on the respective positioning information. The offset may be added on purpose, i.e., in addition to a measurement tolerance or accuracy.

The respective positioning information may indicate directly a global or absolute position of the virtual reference point or a relative position of the virtual reference point with reference to a reference system, for example a global location on earth or a reference system defined in the wireless communication network. The respective positioning information may indicate an identifier (ID) referring to a predefined absolute or relative position. The respective positioning information may be indicated by using a specific resource for transmitting the beamformed signal. The specific resources identifying the virtual reference points may be predefined. In particular in TDD and FDD technologies, a resource may represent a “time-frequency radio resource”. With regard to LTE or 5G NR technologies, a time-frequency radio resource may relate to at least one resource block and is therefore characterised by time slot(s) and the frequency range(s) of its subcarriers. For example, the plurality of resource blocks may comprise the resource blocks within a frame or some subsequent frames and within a predetermined frequency range (for example in FR1 and/or FR2 defined in 5G NR).

Coding the respective positioning information in a relative position, an identifier or a resource may contribute to reduce the amount of data to be communicated.

The method may further comprise transmitting a message indicating that the respective positioning information of the at least one beamformed signal is indicative of a respective virtual reference point. Thus, the device which receives the beamformed signal knows that the positioning information indicated in the beamformed signal does not represent the real origin from which the beamformed signal has been transmitted. This may contribute to not confuse the device when it receives different virtual reference points in different beamformed signals or over time when moving in an environment of the network node. Based on this information, the device may nevertheless trust in the received beamformed signals for determining its position.

According to various examples, the method further comprises transmitting a positioning information mapping indicative of an assignment of the respective positioning information to the respective virtual reference point for each of the at least one beamformed signal. The mapping may indicate for example an assignment of the above identifier (ID) or the above resource to the virtual reference point. The positioning information mapping may be transmitted separately from the beamformed signal, for example when the device registers at the wireless communication network. The positioning information mapping may be retransmitted when being changed by the network. The positioning information mapping may comprise a table or function defining the above described assignment. The positioning information mapping may also, at least partly, be realized as a database which may be accessed by the device occasionally or periodically. The positioning information mapping may be static or semi-static and may comprise further information, for example information on a beam radiation angle of the beamformed signal.

The method may further comprise transmitting a message indicating that the respective virtual reference points are dynamically changed with subsequent beamformed signals of a same transmit direction. In other words, subsequently transmitted beamformed signals may indicate different virtual reference points although the subsequently transmitted beamformed signals indicate a same direction and may indicate that they are transmitted from the same network node. The virtual reference point may be varied based on a timer, in regular terms or with every or every n-th transmission of the beamformed signal or according to predefined pattern. The currently assigned virtual reference point may be dynamically indicated in each beamformed signal, either directly or via an ID, a resource or a mapping as described above. Thus, the device is informed that the positioning information indicates virtual reference points which may be used by the device for determining its position, but which do not indicate the real position of the network node or an antenna array from which the beamformed signals are transmitted.

According to the method, the at least one beamformed signal comprises multiple beamformed signals. Furthermore, according to the method, the virtual reference points of the multiple beamformed signals are offset from the position of the corresponding (real) transmit point along a respective transmit direction of the respective beamformed signal. Each beamformed signal may have a main axis along which the radio frequency signal propagates. The real transmit point, from which the beamformed signal is actually transmitted, is thus arranged on this main axis. The virtual reference point may be arranged in an arbitrary location along this main axis, but offset a distance from the real transmit point. The virtual reference point can be offset in the direction in which the beamformed signal propagates, thus “in front of” the real transmit point as seen from a device receiving the beamformed signal. Or, the virtual reference point can be offset in the opposite direction, thus “behind” the real transmit point as seen from a device receiving the beamformed signal. In any case, the device cannot easily determine the location of the real transmit point.

In various examples, the positioning information indicates a direction information for the device to determine its position based on the direction information. The direction information is indicative of a respective transmit direction of the beamformed signal. In other words, the direction information indicates the direction in which the beamformed signal propagates. For example, the direction may be indicated by an azimuth and angle of elevation with reference to a reference system or earth.

The positioning information may be indicative of a virtual timing information for the device to determine its position. The virtual timing information is based on a distance between the virtual reference point and the position of the transmit point.

For example, the virtual timing information may comprise a phase information to be used for transmitting the corresponding beamformed signal. The phase information may be based on a distance between the virtual reference point, an operating frequency, and the position of the transmit point. For example, the phase may be adjusted such that when the beamformed signal is received at the device along the propagation direction of the beamformed signal, it appears, based on the adjusted phase, as if the beamformed signal has been transmitted from the virtual reference point although it has actually been transmitted from the (real) transmit point. In further examples, the virtual timing information may comprise a timestamp indicating such a transmission start time that it appears to the device which receives the beamformed signal as if the beamformed signal has been transmitted from the virtual reference point. For example, if the virtual reference point has been virtually moved “behind” the real transmit point, the timestamp may be moved in the past such that the delay caused by propagation of the beamformed signal from the real transmit point to the device appears to be longer. Consequently, the device assumes that the distance to the origin of the beamformed signal is further away than it is in reality. The device assumes that the beamformed signal has been transmitted from the virtual reference point. A similar adaption may be performed on phase information.

The phase information may comprise for example a cyclic shift sequence, e.g. a Zadoff-Chu sequence or gold sequence comprised in the beamformed signal. However, any other time information may be used which may enable the device to determine, based on the propagation time of the beamformed signal in a specific carrier frequency, a distance from the virtual reference point to the device. For example, for a gold sequence the device may compute the correlation between the original known sequence and the received sequence and from this the device may obtain a CIR (channel impulse response). The CIR includes a delay profile. The network node may modify the transmitted sequence (cyclic shift) to achieve this delay profile to reflect the transmission from the virtual reference point.

Additionally, a propagation model of the radio channel may be utilized for determining the virtual timing information, for example considering a propagation path of the

Based on the direction information, the device may determine a line or axis along which it is arranged. This may be determined based on a single received beamformed signal. Based on the virtual timing information, the device may determine its distance to the virtual reference point, for example based on the time of flight of the beamformed signal. Thus, a positioning of the device may be accomplished based on a single beam.

For gaining a time reference and deriving its position, the device may need to receive beamformed signals from multiple network nodes. A relative time reference may then be used to derive the position based on an assumption that the network nodes are a time synchronized. With a single network node, the device may only estimate its position based on that it is in the coverage area of the beam (some area or sector). With two network nodes, the device knows additionally a beam crossing point and positioning accuracy may be improved, for example an area within the mutual coverage areas from two beamformed signals of the two network nodes. Three or more network nodes may contribute to further improve the positioning accuracy.

In various examples, the positioning information is indicative of a timing correction information for the device to determine its position based on a timing information of the respective beamformed signal and the timing correction information. The timing information may indicate a start time of the transmission of the beamformed signal at the real transmit point or may be configured such that the device can determine a time of flight of the beamformed signal from the real transmit point to the device, e.g. based on a phase information of the beamformed signal. The timing correction information is based on a distance between the virtual reference point and the position of the (real) transmit point. When the network node indicates a virtual reference point in the beamformed signal as the virtual origin of the beamformed signal, the network node may include, in the timing correction information, a time duration or a phase shift corresponding to a traveling time required for a radio signal to travel along the offset between the virtual reference point and the real origin of transmission. The device may use this timing correction information in combination with the received timing information to determine the distance from the device to the virtual reference point. In this example, the network node does not need to modify the timing information, i.e. the network node does not need to provide the above described virtual timing information in combination with the beamformed signal.

In various examples, the positioning information is indicative of a power correction information for the device to determine its position based on a received power of the respective beamformed signal and the power correction information. The power correction information is based on a distance between the virtual reference point and the position of the (real) transmit point. A distance between a point of transmission of a radio signal and a point of reception of the radio signal may be determined based on a power of the radio signal as a received at the device and a power level with which the beamformed signal was transmitted. The power level with which the beamformed signal was transmitted may be known to the device, for example, the power level may be specified for the communication network. When the network node indicates a virtual reference point in the beamformed signal as the virtual origin of the beamformed signal, the network node may include a power loss or power gain induced by the offset of the virtual reference point from the real origin of transmission in the power correction information. The device may use this power correction information in combination with the received power to determine the distance from the device to the virtual reference point.

The power correction information may be based additionally on a path propagation model. The path propagation model may consider radio channel properties like path loss, attenuation, and frequency dependent path loss. The propagation model of the radio channel between the virtual reference point and the device may include an extrapolation of the radio channel between the position of the transmit point and the device.

According to further examples, the method may comprise transmitting a power correction mapping indicative of a mapping of the respective positioning information to a power correction information for each of the at least one beamformed signal. The power correction information may be used by the device to determine its position based on a received power of the respective beamformed signal and the power correction information. The power correction information is based on a distance between the virtual reference point and the position of the (real) transmit point. Thus, the power correction information may only be distributed once to the devices and may not need to be included in the beamformed signals. The respective positioning information of the beamformed signal may include an identifier or a reference to an entry of the power correction mapping only.

According to various examples, a transmit power used for transmitting the beamformed signal is based on a distance between the (real) transmit point and the virtual reference point. For example, when the network node determines a virtual reference point “behind” the real transmit point as seen from the device, the network node may decrease the transmit power such that it appears to the device that the beamformed signal has been transmitted from the virtual reference point and therefore has a lower power than being transmitted from the real transmit point. Additionally, the transmit power may be based on the path propagation model considering radio channel properties as described above.

Determining the virtual reference point and the corresponding positioning information may be performed by the network node. In particular, the network node may determine, for each one of the at least one beamformed signal, the respective virtual reference point. The respective virtual reference point is offset from the position of the transmit point of the wireless communication network used for transmitting the at least one beamformed signal. The respective virtual reference point may be arbitrarily determined by the network node or according to the predefined scheme and may be varied over time. Furthermore, the network node may determine for each one of the at least one beamformed signal, the respective positioning information. The respective positioning information is indicative of the respective virtual reference point.

According to various examples, a method for determining a position of a wireless communication device in a wireless communication network is provided. In the following, the wireless communication device will also be called simply “device” or “terminal device”. The method comprises receiving at least one beamformed signal. Each one of the at least one beamformed signal is indicative of a respective positioning information. Further, according to the method, an indication is received. The indication indicates that the respective positioning information is indicative of a respective virtual reference point which is offset from a position of a (real) transmit point of the wireless communication network used for transmitting the at least one beamformed signal. The indication may be provided in the positioning information of the beamformed signal. Based on the positioning information and the indication, the device determines its position.

The indication may be provided in a separate message. For example, the method may comprise receiving a message indicating that the respective positioning information of the at least one beamformed signal is indicative of the respective virtual reference point. Based on the indication that the at least one beamformed signal is indicative of the respective virtual reference point the device determines the position of the device by itself.

Thus, the device knows that the positioning is based on virtual reference points.

According to various examples, the indication may be provided as a positioning information mapping. The positioning information mapping may be received from a network node of the wireless communication network and may be indicative of a mapping of the respective positioning information to the respective virtual reference point for each of the at least one beamformed signal. The wireless communication device may determine its position based on the positioning information mapping.

The positioning information mapping may be transmitted separately from the beamformed signal, for example when the device registers at the wireless communication network. The positioning information mapping may be retransmitted when being changed by the network. The positioning information mapping may comprise a table or function assigning identifiers or resources to virtual reference points.

In further examples, the method comprises receiving a message indicating that the respective virtual reference points are dynamically changed, e.g. subsequent beamformed signals having a same transmit direction may relate to different virtual reference points. The virtual reference points may be varied based on a timer or randomized. Based on the indication that the respective virtual reference points are dynamically changed, the device may determine its position without being confused that the reference points on which the positioning is based varies.

The positioning information may indicate a direction information. The direction information may indicate a respective transmit direction of the beamformed signal, for example a direction of a main propagation direction of the beamformed signal. According to the method the position of the wireless communication device may be determined based on the direction information.

Furthermore, the positioning information may indicate a virtual timing information. The position of the wireless communication device may be determined based on the virtual timing information.

The virtual timing information may comprise a phase information, e.g. cyclic shift or Zadoff-Chu sequence or gold sequence comprised in the beamformed signal or any other time information which may be used by the device to determine, based on the propagation speed of the beamformed signal (speed of light), a distance from the virtual reference point to the device. The virtual timing information may comprise for example a virtual transmission start time.

The position of the wireless communication device may be determined based on a cross correlation between the received beamformed signal and a corresponding timing signal provided at the user equipment. For example, the timing signal may be based on a timing synchronization of the device with a timing of one or more network nodes or a timing source of the wireless communication network.

According to various examples, the positioning information is indicative of a power correction information. The method may comprise determining the position of the wireless communication device based on a received power of the respective beamformed signal and the power correction information. Based on the received power and the power correction information, the device may determine a distance from the device into the virtual reference point.

According to further examples, the device may receive a power correction mapping indicative of a mapping of the respective positioning information to a power correction information for each of the at least one beamformed signal. Based on a received power of the respective beamformed signal and the power correction information, the device may determine the position of the wireless communication device.

According to further examples, a network node in a wireless communication network is provided. The network node comprises a transmitter configured to transmit at least one beamformed signal, and control circuitry. The control circuitry is configured to determine, for each one of the at least one beamformed signal, a respective virtual reference point. The respective virtual reference point is offset from a position of a transmit point of the wireless communication network used for transmitting the at least one beamformed signal. The control circuitry is further configured to determine, for each one of the at least one beamformed signal, a respective positioning information. The respective positioning information is indicative of the respective virtual reference point. The beamformed positioning signal is suitable for enabling a positioning measurement of a wireless communication device.

The network node may be configured to perform the above-described method and the embodiments thereof.

According to further examples, a wireless communication device in a wireless communication network is provided. The device comprises a receiver configured to receiving at least one beamformed signal. Each one of the at least one beamformed signal is indicative of a respective positioning information. The device comprises furthermore control circuitry configured to receive an indication indicating that the respective positioning information is indicative of a respective virtual reference point which is offset from a position of a transmit point of the wireless communication network used for transmitting the at least one beamformed signal. Based on the positioning information and the indication, the control circuitry is configured to determine the position of the wireless communication device.

The device may be configured to perform the above-described method and the embodiments thereof.

Although specific features in the above summary and the following detailed description are described in connection with specific embodiments and aspects of the present invention, it should be understood that the features of the exemplary embodiments and aspects may be combined with each other unless specifically noted otherwise. In particular, the assignment of the roles in several examples that the device is the device which determines its position and that the network node provides the beamformed positioning signals may be reversed or modify such that the network node or another device detects the beamformed signals transmitted from the device and determines the position of the network node or the other device based on the beamformed signals.

### BRIEF DESCRIPTION OF THE DRAWINGS

Embodiments of the invention will be described in more detail with reference to the accompanying drawings.

FIG. 1 shows schematically a wireless communication network comprising a network node and a wireless communication device.

FIG. 2 shows schematically a wireless communication network comprising a network node and a wireless communication device according to various examples.

FIG. 3 shows schematically a method according to various examples in which a virtual reference point is offset from a real transmit point.

FIG. 4 shows a flowchart of a message flow between a network node and a device according to various examples.

FIG. 5 shows a flowchart of a message flow between a network node and a device according to further examples.

FIG. 6 shows schematically a network node according to various examples.

FIG. 7 shows schematically a device according to various examples.

FIG. 8 shows a flowchart of a method performed by a network node according to various examples.

FIG. 9 shows a flowchart of a method performed by a device according to various examples.

### DETAILED DESCRIPTION OF THE EMBODIMENTS

In the following, exemplary embodiments of the present invention will be described in more detail. It is to be understood that the features of the various exemplary embodiments described herein may be combined with each other unless specifically noted otherwise. Any coupling between components or devices shown in the figures may be a direct or indirect coupling unless specifically noted otherwise.

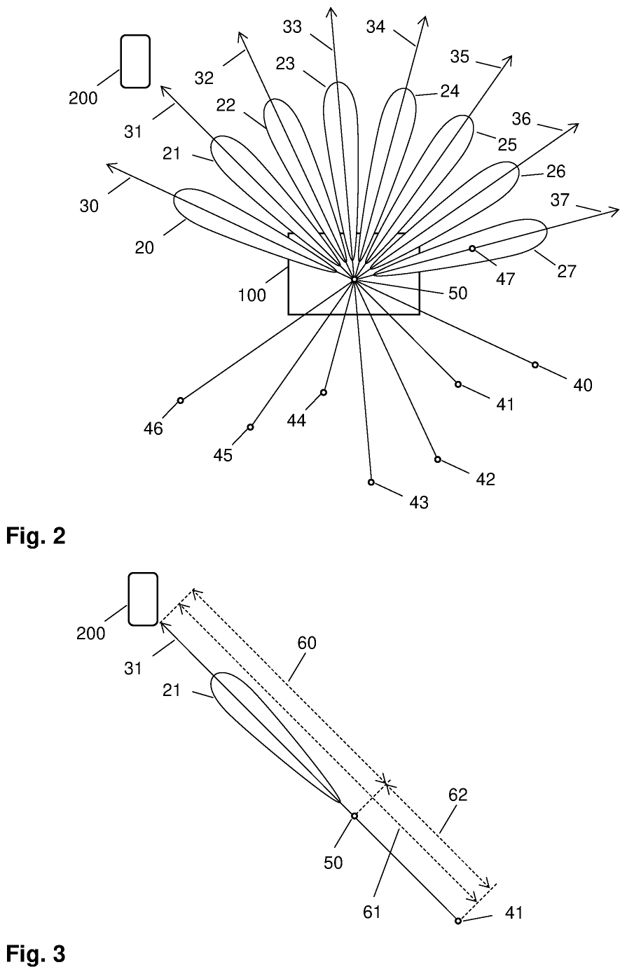

FIG. 2 illustrates a positioning technology using beamformed positioning reference signals. A beamformed positioning reference signal is a radio frequency signal which is transmitted in a defined direction using beamforming. Essentially, the beamformed positioning reference signal may have a main lobe in a defined direction and may thus essentially cover a certain sector only. An opening angle of the sector may be in a range of a few degrees, for example 5° to 30° in horizontal and/or vertical direction. The beamformed positioning reference signal may be transmitted in a downlink direction and may comprise information which enables a receiving device to determine its position based on information provided in the beamformed positioning reference signal only. Using a plurality of beamformed positioning reference signals from different directions may increase accuracy of positioning at the device. In the following, a beamformed positioning reference signal will also be called beamformed signal or positioning reference signal.

Returning to FIG. 2. A network node 100 comprises an antenna array 50 configured to transmit beamformed signals 20 to 27 in different directions 30 to 37. The antenna array 50 may comprise a plurality of antenna elements for establishing the transmission of the beamformed signals 20 to 27. The antenna array 50 may be located nearby the network node 100 or spaced apart from the network node 100. Each beamformed signal 20 to 27 is transmitted from the antenna array 50 such that the beamformed signals 20 to 27 share a common origin which is located at the antenna array 50. The origin or position of the transmit point from where the beamformed signals 20 to 27 are transmitted is the same for all beamformed signals 20 to 27 and corresponds to the position of the antenna array 50. Therefore, in the following, the position of the transmit point from where the beamformed signals 20 to 27 are transmitted will also be designated with reference sign 50, i.e. origin 50 or (real) transmit point 50.

Each beamformed signal 20 to 27 includes direction information indicating a direction of the beam. The directions of the beams are indicated in FIG. 2 by reference signs 30 to 37. Direction 30 indicates the direction of beamformed signal 20, direction 31 indicates the direction of beamformed signal 21, direction 32 indicates the direction of beamformed signal 22 and so on. The direction information may be indicated in the beamformed signal by an azimuth and elevation angle. However, in case a two dimensional positioning is required only, the direction information may be indicated in the beamformed signal by an azimuth only.

Each beamformed signal 20 to 27 includes a position information indicating a virtual origin from which each of the beamformed signals 20 to 27 is virtually transmitted. “Virtually transmitted” means that the beamformed signal has been physically transmitted from origin 50, but from the position information it appears as if the beamformed signal has been transmitted from a virtual reference point which is offset from the origin 50 along the direction of the corresponding beamformed signal. For example, beamformed signal 20 includes a position information indicating a virtual reference point 40 which is offset from the physical origin 50 along the direction 30. As can be seen in FIG. 2, the virtual reference point 40 is offset in the direction 30 “behind” the physical origin 50 as seen from a device which is allocated in a sector covered by the beamformed signal 20. Furthermore, as shown in FIG. 2, beamformed signal 21 includes a position information indicating a virtual reference point 41 which is offset from the physical origin 50 along the direction 31. The virtual reference point may also be offset such that it appears from the receiving device as if the virtual reference point is closer to the device than the physical origin 50. Such an example is shown in connection with beamformed signal 27. Beamformed signal 27 may include a position information indicating a virtual reference point 47 which is offset from the physical origin 50 along the direction 37. The virtual reference point 47 is offset in the direction 37 “in front of” the physical origin 50 as seen from a device which is located in a sector covered by the beamformed signal 27.

The position information indicating the origin may comprise an absolute global position or a relative position with respect to a predefined global position or a predefined reference system. Each beamformed signal 20 to 27 includes a virtual timing information which enables a receiving device to determine a distance between the device and the corresponding virtual reference point 40 to 47 based on the time of flight of the received beamformed signal 20 to 27. In the example shown in FIG. 2, a device 200 is located in a sector covered by beamformed signal 21. Upon receiving the beamformed signal 21, the device 200 may determine its position with respect to the virtual reference point 41 based on the direction information and virtual timing information included in the beamformed signal 21. In connection with the position information concerning the virtual reference point 41, the device 200 may determine its global position or relative position with respect to a reference system.

One effect of the above described concept is that, from an algorithm perspective, for the device 200 there is no difference whether its position estimate is based on the virtual origin 41 of the beamformed signal 21 or based on the “real” origin 50 of the beamformed signal 21. However, the network node 100 does not reveal its position. A limitation of the positions of the virtual reference points may be a time window in which the positioning reference signal needs to be transmitted. If the virtual position is too far away it may not hit the measurement window at the device.

FIG. 3 shows the above described concepts in more detail. The beamformed signal 21 may comprise a beamformed positioning reference signal (PRS). The virtual timing information included in the positioning reference signal 21 may indicate a timestamp information from which the receiving device 200 may determine the point of time when the positioning reference signal 21 was allegedly transmitted from the virtual reference point 41. The traveling time of the positioning reference signal 21 for propagating from the virtual reference point 41 to the device 200 may be determined based on the virtual timing information. For example, the network node 100 may add a delay or phase shift (either positive or negative depending on the direction in which the virtual reference point is offset from the origin 50 along the direction 31) to emulate that the beamformed signal 21 has traveled a longer or shorter distance than the actual distance from the origin 50. The delay represents the time it would take the beamformed signal to travel the distance between the virtual reference point 41 and the origin 50. The phase shift represents a shift in phase of the beamformed signal which would occur when the beamformed signal would travel from the virtual reference point 41 to the origin 50. In FIG. 3, the beamformed signal 21 is transmitted from the origin 50.

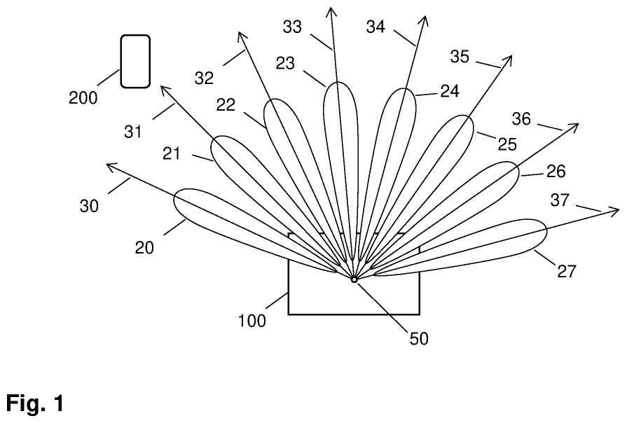

Usually, as shown in FIG. 1 without offset virtual reference points, the device 200 obtains a Time of Arrival (ToA). The ToA is determined by estimating time delay obtained from the cross-correlation output of the received PRS and a replica/stored PRS at the device 200. The replica/stored PRS may be synchronized to a network timing, for example to a frame structure of the network nodes defined in the communication network. For example, in LTE the network timing may be based on a transmission of synchronization signals, e.g. primary synchronization signal (PSS) and secondary synchronization signal (SSS), and in 5G NR the network timing may additionally be based on information of the synchronization signal block (SSB). The device 200 determines its position based on origin 50, the distance 60 and the direction 31.

According to the concepts shown in FIG. 2 and FIG. 3, the PRS generated at the network node is modified such that its virtual timing information is also a function of a distance 61 between origin 50 and the virtual reference point 41 and modified by:

Δt=(R −R)/c

wherein R′ is the location of virtual reference point 41, R is the location of origin 50, and c is the speed of light.

The PRS generated at the network node indicates a virtual timing information modified by Δt such that the device 200 receiving the generated PRS determines a traveling distance 61 for the PRS traveling from virtual reference point 41 to the device 200. The virtual timing information Δt is equivalent to the distance 62. As described above, the device 200 may perform cross-correlation of the received modified PRS and the replica/stored PRS. The cross-correlation output is further processed in order to obtain a time delay information. The time delay information is further used for determining the distance 61.

It is to be noticed that the virtual reference points 40 to 47 are different for each beamformed signal 20 to 27. The offsets for the virtual reference points 40 to 47 may be selected individually and may be different for each beamformed signal 20 to 27. However, all beamformed signals may have the same absolute offset, but in different directions. The same absolute offset may lead to the same time offset Δt to be applied for modifying the corresponding virtual timing information of the beamformed signals.

Furthermore, instead of a timing based distance determination, the distance between the device 200 and the virtual reference points 40 to 47 may be determined based on a reference signal received power (RSRP) based positioning. The distance between the origin 50 and the virtual reference points 40 to 47 may then be associated with a power offset Δp that corresponds to a path loss of Δp induced by the additional virtual propagation path 62. A power correction information may be included in the beamformed signal to provide information for the device 200 to determine the distance 61 between the virtual reference point 41 and the device 200 based on the received power.

Timing or power information required by the device 200 for determining the distance 61 may be provided in mapping information which may be communicated from the wireless communication network to the device 200 separately from transmitting the beamformed signals 20-27. The beamformed signals 20-27 may then only contain an identifier referencing to timing or power information in the mapping information. In further examples, the beamformed signals 20-27 may be transmitted in specific resources defined in the wireless communication network. The specific resources may be related to timing or power information in the mapping information. Thus, the amount of information communicated in the beamformed signals 20 to 27 may be reduced.

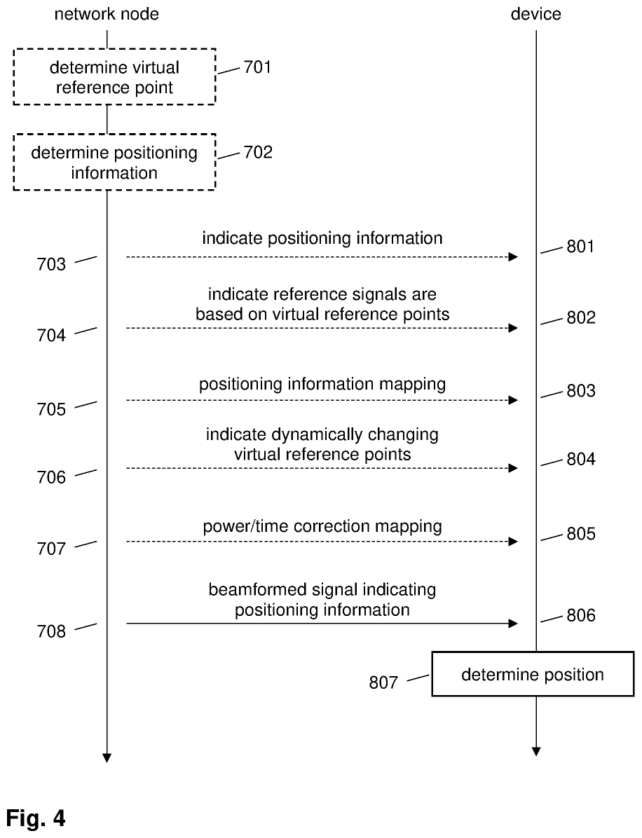

FIG. 4 shows a flowchart of communication between the network node 100 and the device 200. Steps and transmissions indicated with dashed lines may be optional.

In step 701 the network node 100 determines for each beamformed signal 20 to 27 a respective virtual reference point 40 to 47. The respective virtual reference points 40 to 47 are each offset from the position of the real transmit point or origin 50 (the antenna array 50 assigned to the network node 100) from which the beamformed signals 20 to 27 will be transmitted. Each of the virtual reference points 40 to 47 is offset from the position of the origin 50 along the respective transmit direction 30 to 37 of the respective beamformed signal 20 to 27.

In step 702 the network node 100 determines for each beamformed signal 20 to 27 a corresponding positioning information which indicates the respective virtual reference point 40 to 47 for the respective beamformed signal 20 to 27. The positioning information may indicate for example an absolute position of the respective virtual reference point with reference to earth or a relative position of the respective virtual reference point with reference to a reference system defined for the wireless communication network. At 703, the network node 100 and may transmit a message indicating the determined positioning information for the beamformed signals 20 to 27, i.e. the positions of the virtual reference points 40 to 47, for example the absolute position or the relative position of the virtual reference points in a coded form, for example as geographic coordinates. The message may comprise further information, for example a direction information indicating the direction of propagation of the beamformed signals 20 to 27. At 708, the network node 100 may transmit a beamformed signal indicating the positioning information. The beamformed signal may comprise a positioning reference signal. The beamformed signal may include or be indicative of further information, in particular a direction information indicating the direction of propagation of the beamformed signal with respect to the virtual reference point, and a virtual timing information which enables a device receiving the beamformed signal to determine, based on the virtual timing information, a traveling time of the beamformed signal from the virtual reference point to the device. Thus, the distance between the virtual reference point and the device can be estimated.

As explained above in connection with FIG. 3, the virtual reference point does not correspond to the real origin from which the beamformed signal is transmitted. Therefore, the virtual timing information may be determined such that it considers the propagation time from the real origin to the receiving device 200 (distance 60) and the propagation time from the virtual reference point to the real origin (distance 62). At 801 the device 200 may receive the message indicating the determined positioning information for the beamformed signals 20 to 27. At 806 the device 200 may receive the beamformed signal and may extract the absolute position or the relative position of the virtual reference point from the positioning information indicated in the received beamformed signal. Based on the absolute or relative position of the virtual reference point, the direction information and the virtual timing information, the device 200 may determine at 807 its own position, for example as an absolute position with respect to earth or a relative position with respect to a reference coordinate system.

In various examples, at 704 the network node 100 may transmit a message to the device 200. The message indicates that the positioning information provided in beamformed positioning reference signals does not indicate the real position of the origin of the beamformed signals, but virtual reference points. The device 200 may receive this message at 802. This information may be useful for the device 200 for the following reasons: When the device is moving, it may receive different beamformed signals from the same network node, but these different beamformed signals have different directions and consequently different virtual reference points. Thus, from the point of view of the device 200, the location of the network node 100 is varying. Due to this varying location, the device may not trust these positioning reference signals and may refuse them. However, by indicating that the positioning reference signals indicate virtual reference points, the device 200 may nevertheless trust in these positioning reference signals and may use them for determining its position. Further, a similar uncertainty may result at the device 200 when the network node 100 varies the virtual reference point for subsequently transmitted positioning reference signal having the same beamforming. However, transmitting the message in step 704 may be optional and the device may use the beamformed signals indicating the virtual reference points without knowing that the indicated virtual reference points do not indicate the real origin of the beamformed signal.

In further examples, the positioning information may comprise an identifier which identifies, in connection with a positioning information mapping described below, a relative or absolute position of the respective virtual reference point. In a corresponding positioning information mapping a relative or absolute position of the respective virtual reference points may be defined for each identifier.

In further example, the network node may determine for each beamformed signal 20 to 27 a corresponding resource defined in the wireless communication network. In a corresponding positioning information mapping, a relative or absolute position of the respective virtual reference points may be defined for each resource used for transmitting the beamformed signals 20 to 27.

For example, at 705 the network node may transmit a message indicating a positioning information mapping. This message may be transmitted once after the device 200 has registered at the network node 100, in regular terms, upon request from the device 200, upon a change in the mapping or according to any other trigger. The message including the mapping may be received by the device at 803.

The mapping may indicate an assignment of resources to virtual reference points. The resources may be resources defined in the communication network for transmitting downlink information, for example time-frequency resources. The beamformed signal may be transmitted at 708 using the resource assigned to the beamformed signal. The mapping may contribute to reduce the amount of data to be transmitted in the beamformed signals. For example, each beamformed signal may be transmitted at 708 by the network node 100 using the resource assigned to the corresponding beamformed signal; this transmission can implement the reference signal or, more specifically the PRS as described above. In particular, the transmission can have characteristics of a conventional PRS, e.g., sequence design, signal properties, bandwidth, QPSK sequence, etc. The device 200 may receive the beamformed signal at 806 and may determine, based on the mapping and the resource in which the beamformed signal was received, the virtual reference point assigned to this beamformed signal.

In other examples, the mapping may indicate an assignment of identifiers to virtual reference points. The network node 100 may transmit at 708 a beamformed signal indicating an identifier which is assigned to the virtual reference points of the beamformed signal. The device 200 may receive the beamformed signal at 806. Based on the mapping and the identifier, the device 200 may determine the virtual reference point assigned to this beamformed signal.

In further examples, the network node 100 may transmit at 706 a message indicating that the virtual reference points are changing dynamically. For example, the network node 100 may vary the position of the virtual reference points for a single direction after each transmission of the beamformed signal in the corresponding direction. In other examples, the network node 100 may vary the position of the virtual reference points in regular intervals. The device 200 may receive the message indicating that the virtual reference points are changing dynamically at 804. Communicating that the virtual reference points are changing dynamically may be useful for the device 200. The device may receive subsequence beamformed signals from the same network node in the same sector, but these subsequent beamformed signals have different origins because the virtual reference points are changing dynamically. Thus, from the point of view of the device 200, the location of the network node 100 is varying. The device may not trust these positioning reference signals and may refuse them. However, by indicating that the origins indicated in the positioning reference signals may change dynamically, the device 200 may nevertheless trust in these positioning reference signals and may use them for determining its position.

As described above, in step 702 the network node 100 determines for each beamformed signal 20 to 27 a corresponding positioning information which indicates the respective virtual reference point 40 to 47 determined for the respective beamformed signal 20 to 27. The device 200 may determine its position based on the virtual reference point, a direction information included in the beamformed signal, and the distance between the virtual reference points and the device 200. Instead of basing the distance determination on a virtual timing information included in the beamformed signal, the device 200 may utilize a power with which the beamformed signal is received at the device 200. For example, the network node 100 may transmit at 708 the beamformed signal with a predefined power. The device 200 may determine a path loss by comparing the predefined power used for transmitting the signal at the network node 100 with the power of the beamformed signal as received at the device 200 at 806. Based on the path loss, the device 200 may determine a length of a propagation path of the beamformed signal from the network node 100 to the device 200. As the network node does not include the position of the real origin of the beamformed signal, but the virtual reference point, the network node 100 may adapt the transmit power accordingly or may include a power correction information in the beamformed signal which may be used by the device 200 for correcting the received power such that the determined path loss corresponds to the distance between the virtual reference point and the device 200. A propagation path model may additionally be considered by the device 200 for determining the distance based on the path loss.

In further examples, the power correction information may comprise an identifier which identifies, in connection with a power correction information mapping, a corresponding power correction value for each beamformed signal. In the power correction information mapping, each beamformed signal may be identified based on the identifier or a resource in which the beamformed signal is transmitted.

In further examples, a timing correction factor for each beamformed signal may be communicated from the network node 100 to the device 200, for example in connection with the above described message indicating the positioning information (transmitted at 703). Each timing correction factor may be determined by the network node 100 and based on the corresponding offset between the origin 50 and the corresponding virtual transmit point 40 to 47. Instead of transmitting the beamformed signal using the virtual a timing information, the beamformed signal is transmitted using the real timing information at 708. The device 200 receives the beamformed signal at 806 and determines the distance between the device 200 and the virtual transmit point based on the real timing information and the timing correction factor.

The timing correction information may comprise an identifier which identifies, in connection with a timing correction information mapping, a corresponding timing correction value for each beamformed signal. In the timing correction information mapping, each beamformed signal may be identified based on the identifier or a resource in which the beamformed signal is transmitted.

For example, at 707 the network node 100 may transmit a message indicating the power correction information mapping or the timing correction information mapping. This message may be transmitted once after the device 200 has registered at the network node 100, in regular terms, upon request from the device 200, upon a change in the mapping or according to any other trigger. The message including the power correction information mapping or the timing correction information mapping may be received by the device at 806 and used by the device at 806 for determining its position.

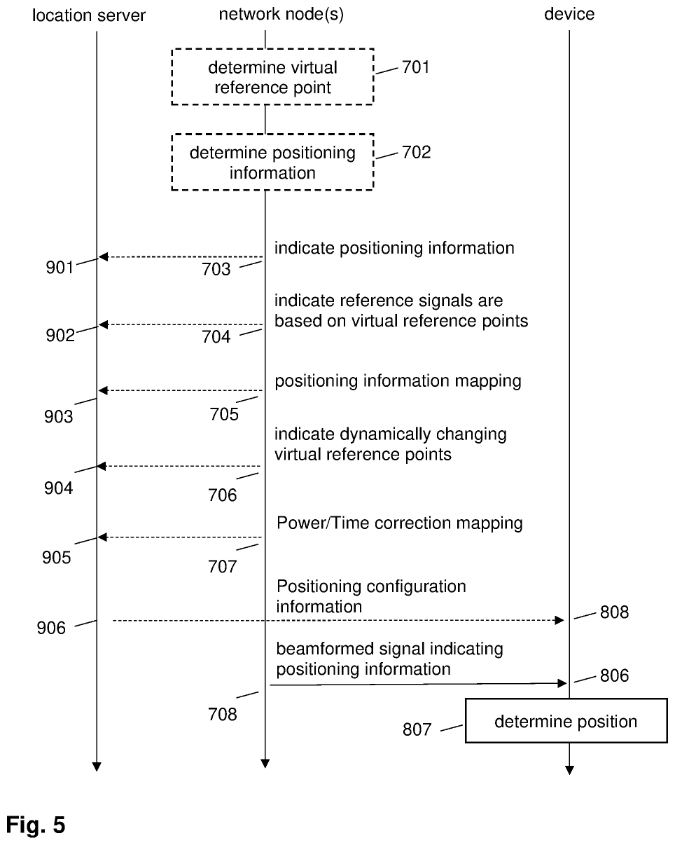

FIG. 5 shows a further example for communicating positioning, timing and power related information to the device 200 by involving a location server. The location server may collect information from a network node currently serving the device 200 and may additionally collect information from neighboring network nodes which may also provide beamformed signals which may be processed by the device 200 for positioning purposes. As indicated in FIG. 5, some or all above described messages transmitted at 703 to 707 indicating the positioning information, the indication that the reference signals are based on virtual reference points, the positioning information mapping, the indication that the virtual reference points are changing dynamically, and/or the power or time correction mapping may be transmitted to the location server. The location server receives the corresponding messages at 901 to 905. The location server may collect the above messages from a plurality of network nodes, for example a base station currently serving the device and base stations of neighboring cells. The aforementioned communicating the information (703-707) may involve a positioning protocol signaling between network node(s) and location server, for example the LTE positioning A protocol (LPPa). The collected information may be transmitted at 906 to the device 200 which receives the configuration information at 808. Communicating the information to the device 200 may involve a positioning protocol signaling, for example the LTE positioning protocol (LPP). After being configured with the information received at 808, the network nodes may transmit beamformed signals indicating the corresponding positioning information at 708, and the device 200 may receive the beamformed signals at 806 for determining its position at 807 as described above. Thus, the beamformed signals transmitted at 708 can implement positioning reference signals, e.g., in accordance with a positioning protocol. The beamformed signals may comprise positioning reference signals configured according to the information communicated at 906/808.

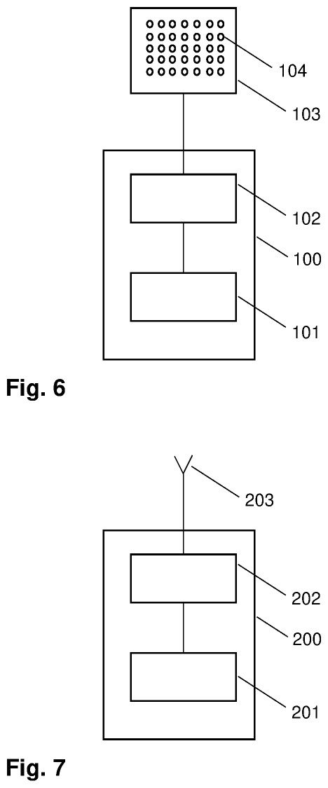

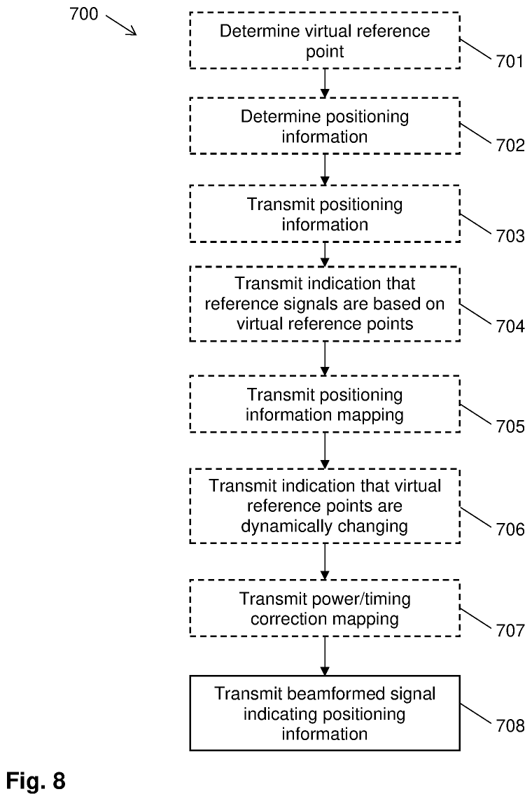

FIG. 6 shows the network node 100 in more detail. The network node 100 may comprise for example an access node of the wireless communication network, for example an eNB of an LTE system or a gNB of a 5G NR system. The network node 100 may comprise control circuitry 101 and a transmitter 102. The network node 100 may comprise more components, in particular for example a receiver, but these components are not shown in the figure for clarity reasons. The network node 100 may comprise furthermore an antenna array 103 comprising a plurality of antenna elements 104. The antenna array 103 may comprise several tens or hundreds of antenna elements 104. The transmitter 102 may be configured to provide radio signals individually to each antenna element 104, for example with an individual phase and an individual power. This may enable the antenna array 103 to transmit beamformed signals as indicated and discussed above in connection with FIG. 2 and FIG. 3. The control circuitry 101 may comprise a controller or digital processor to control the transmitter 102 to transmit beamformed signals as described above in connection with FIG. 4 and FIG. 5 and as described below in connection with FIG. 8.

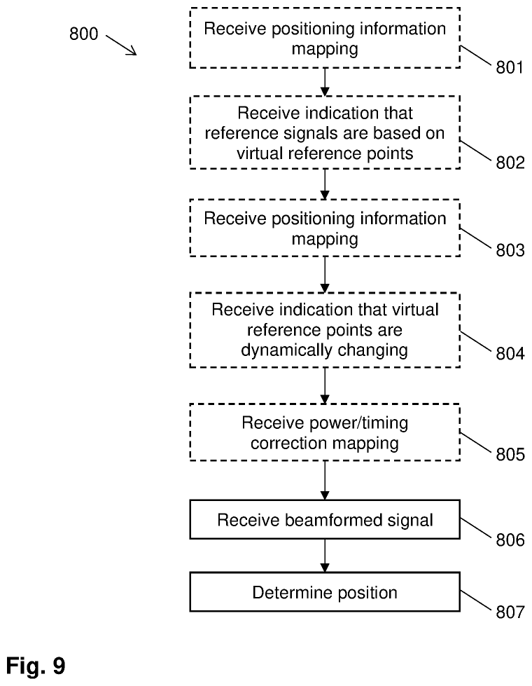

FIG. 7 shows the device 200 in more detail. The device 200 may comprise for example a mobile telephone, like smart phone, or an Internet of things (IoT) device. The device 200 may comprise control circuitry 201 and a receiver 202. The device 200 may comprise more components, in particular for example a transmitter and a user interface, but these components are not shown in the figure for clarity reasons. The device 200 may comprise furthermore an antenna 203 for receiving radio signals emitted from the network node 100. The control circuitry 201 may comprise a controller or digital processor configured to determine a position of the device 200 based on downlink signals received from the network node 100 as described above in connection with FIG. 4 and FIG. 5 and as described below in connection with FIG. 9.

FIG. 8 shows method steps 701 to 708 of a method 700 which may be performed by the network node 100. The method steps in dashed boxes may be considered as optional method steps. The method steps 701 to 708 correspond essentially to the steps and transmissions 701 to 708 described in FIG. 4.

In step 701, the network node 100 may determine, for each of a plurality of beamformed signals, a virtual reference point. The virtual reference points of the plurality of beamformed signals are offset from a position of a (real) transmit point from which the beamformed signals are transmitted. The transmit point may essentially be the position of the antenna array 103. In particular, each virtual reference point of a corresponding beamformed signal is offset from the position of the real transmit point along the respective transmit direction of the respective beamformed signal. The network node may be configured to transmit the plurality of beamformed signal such that each of the beamformed signals covers a sector in an environment of the network node. In step 702, the network node may determine for each of the plurality of beamformed signals a respective positioning information. The respective positioning information indicates the respective virtual reference point, for example as an absolute or relative geographical coordinate or an identifier or a resource as explained above in connection with FIG. 4. In step 703, the network node may transmit a message indicating the positioning information for each beamformed signal.

In step 704, the network node 100 may transmit a message indicating that the respective positioning information of the beamformed signals is indicative of a respective virtual reference point. Furthermore, in step 705, the network node may transmit a positioning information mapping which indicates a mapping of the respective positioning information, for example identifiers, to the respective virtual reference point for each of the beamformed signals. Furthermore, in step 706, the network node may transmit a message which indicates that the respective virtual reference points are dynamically changed with subsequent beamformed signals of the same transmit direction. In step 707 the network node may transmit a power correction mapping which indicates a mapping of the respective positioning information to a power correction information for each beamformed signal. The power correction information may be used by the device 200 to determine its position based on a received power of the respective beamformed signal and the power correction information. The power correction information is based on the distance between the virtual reference point and to the position of the transmit point. Additionally or as an alternative, in step 707 of the network node may transmit a time correction mapping which indicates a mapping of the respective positioning information to a time correction information for each beamformed signal.

Finally, in step 708, the network node 100 transmits at least one beamformed signal of the plurality of beamformed signals. The transmitted beamformed signal indicates the respective positioning information and may additionally indicate a direction information and/or a virtual timing information and/or a power correction information. The direction information indicates a respective transmit direction of the beamformed signal. The virtual timing information is based on the distance between the virtual reference points and the position of the transmit point. For example, the virtual timing information may indicate a transmission start time which does not correspond to the start time of the real transmission, but which is modified by a time duration required for a radio signal to travel from the virtual reference point to the real transmit point. The power correction information is also based on the distance between the virtual reference points and the position of the transmit point. For example, the power correction information may indicate a power loss experienced by a radio signal traveling from the virtual reference points to the real transmit point.

FIG. 9 shows a method 800 comprising method steps 801 to 807 which may be performed by the device 200. The method steps in dashed boxes may be optional. The method steps 801 to 807 correspond essentially to the steps and transmissions 801 to 807 described in FIG. 4.

In step 801, the device 200 may receive a message which indicates position information for beamformed signals which may be received and processed by the device 200. In step 802, the device 200 may receive a message which indicates that positioning information received in beamformed signals is indicative of a respective virtual reference point. Additionally or as an alternative, in step 803, the device 200 may receive a positioning information mapping which indicates a mapping of respective positioning information to respective virtual reference points for each of a plurality of beamformed signals. The device 100 may determine the position of the device 100 based on the received beamformed signals and the positioning information mapping. Furthermore, the device 100 may receive in step 804 a message indicating that the respective virtual reference points are dynamically changed with subsequent beamformed signals of a same transmitted direction. This information may also be considered by the device 100 when determining its position. Furthermore, in step 805, the device 100 may receive a power correction mapping which indicates a mapping of respective positioning information to power correction information for each received beamformed signal. The device 100 may use the power correction information retrieved from the power correction mapping when determining the position of the device 100 based on the received power of the respective beamformed signal. Additionally, in step 805, the device 100 may receive a timing correction mapping which indicates a mapping of respective positioning information to timing correction information for each received beamformed signal.

In step 806 the device 100 receives at least one beamformed signal which is indicative of the respective positioning information. The received beamformed signal may include further information, for example direction information and virtual timing information. In step 807, the device 100 determines, based on the information provided in the beamformed signal, its position additionally considering that the positioning information indicates the respective virtual reference point which is offset from a position of the transmit point from which the beamformed signal is actually transmitted.

To sum up, the position of the virtual reference point of a beamformed signal is randomly or deterministically selected along the propagation direction of the beamformed signal, in general anywhere along this beam at either side of the receiving device (if the device position is known) or at either side of the antenna array of the network node. This virtual position is broadcasted in each beamformed signal together with direction information and a timestamp (e.g. a start time of transmission). The beamformed positioning reference signal (PRS) is modified as function of a delay value, in which the delay represents the relative position between the virtual reference point and the true/real origin. The time stamp is defined to match the selected virtual position so that the receiving device can use the time stamp to estimate the distance between the device and the selected virtual position (i.e. ToF). If the virtual position is on the opposite side of the device than the antenna array, this time can be negative. The same beam can change the virtual position and the associated timestamp at different time occasions or frequency carriers. As an alternative, the distance between the device and the selected virtual position may be determined based on a power received at the device and a correspondingly provided power correction information.

The techniques described herein can support UE-based position by allowing the UE to perform both positioning measurements and positioning estimation. The techniques described herein are based on the finding that, generally, positioning estimation can only be performed once the UE knows a location of one or more reference points. In this case, the reference point(s) are the TRP(s)—i.e., transmit point(s)—that transmit positioning reference signal (PRS) for positioning measurement. The UE requires the absolute position of the transmit point(s). The absolute position of the transmit point(s) can be included in a broadcast transmission to all or some of the UEs. Here, it may be possible to limit the broadcast information size (e.g., only one reference point and the rests are the relative position to the reference point.

Broadcasting the true/absolute transmit point position(s) may expose some issues, particularly security issues.

According to various examples described herein, to increase security, the absolute position of the transmit point(s) is only transmitted to some UEs, but not all UEs connected to a cellular network. In this case, it could be the UE who request or has required subscriptions. This may limit the usage of UE-based positioning and the benefit is only applicable to some UEs.

Observation 1: Broadcasting the true position of a transmit point may not be desirable to the network operator and affect the deployment of the UE-based positioning in the real deployment.

Observation 2: Allowing (e.g., only) some UEs to obtain the true position(s) of transmit points may limit the usage of UE-based positioning.

According to the techniques described above, UE-based positioning can be supported without exposing the true reference point of the transmit point. This is based on virtual reference points provided to one or more UEs for the positioning estimation purpose. Virtual reference points can define a virtual position, i.e., a position with a relative non-disclosed distance from the true position.

Proposal 1: Support UE-based positioning by informing the UE of (e.g. unicast/broadcast) a virtual position of a transmit point associated with each beam.

As the true reference point(s) position is not to be used, the TRP needs to convey the relative distance information to the UE. It is possible to manipulate the PRS so that it behaves as if it originated from the virtual TRP position. This can be implemented in a transparent manner from a UE perspective.

Proposal 2: The usage of virtual reference point position for each beam can be supported by conveying the relative distance information in the PRS signal transparent to the UE algorithm.

In this document above, a Virtual Reference point is introduced, in order to not disclose the true TRP or base station location.

1. A method for operating a network node in a wireless communication network, the method comprising:
transmitting at least one beamformed signal, wherein each one of the at least one beamformed signal is indicative of a respective positioning information, wherein the respective positioning information is indicative of a respective virtual reference point which is offset from a position of a transmit point of the wireless communication network used for transmitting the at least one beamformed signal,
wherein the beamformed signal is suitable for enabling a positioning measurement of a wireless communication device.

2. The method of claim 1, further comprising:
transmitting a message indicating that the respective positioning information of the at least one beamformed signal is indicative of the respective virtual reference point.

3. The method of claim 1, further comprising:
transmitting a positioning information mapping indicative of a mapping of the respective positioning information to the respective virtual reference point for each of the at least one beamformed signal.

4. The method of claim 1, further comprising:
transmitting a message indicating that the respective virtual reference points are dynamically changed with subsequent beamformed signals of a same transmit direction.

5. The method of claim 1,
wherein the at least one beamformed signal comprises multiple beamformed signals,
wherein the virtual reference points of the multiple beamformed signals are offset from the position of the transmit point along a respective transmit direction of the respective beamformed signal.

6. The method of claim 1, wherein the positioning information is indicative of a direction information for the device to determine its position based on the direction information, wherein the direction information is indicative of a respective transmit direction of the beamformed signal.

7. The method of claim 1, wherein the positioning information is indicative of a virtual timing information for the device to determine its position, wherein the virtual timing information is based on a distance between the virtual reference point and the position of the transmit point.

8. The method of claim 7, wherein the virtual timing information comprises a phase information to be used for transmitting the corresponding beamformed signal, wherein the phase information is based on a distance between the virtual reference point and the position of the transmit point.

9. The method of claim 1, wherein the positioning information is indicative of a timing correction information for the device to determine its position based on a timing information of the respective beamformed signal and the timing correction information, wherein the timing correction information is based on a distance between the virtual reference point and the position of the transmit point.

10. The method of claim 1, wherein the positioning information is indicative of a power correction information for the device to determine its position based on a received power of the respective beamformed signal and the power correction information, wherein the power correction information is based on a distance between the virtual reference point and the position of the transmit point.

11. The method of claim 1, further comprising:
transmitting a power correction mapping indicative of a mapping of the respective positioning information to a power correction information for each of the at least one beamformed signal, the power correction information being used by the device to determine its position based on a received power of the respective beamformed signal and the power correction information, wherein the power correction information is based on a distance between the virtual reference point and the position of the transmit point.

12. The method of claim 10, wherein the power correction information is based additionally on a path propagation model.

13. The method of claim 1, wherein a transmit power used for transmitting the beamformed signal is based on a distance between the transmit point and the virtual reference point.

14. The method of claim 13, wherein the transmit power is based additionally on a path propagation model.

15. The method of claim 1, further comprising:
determining, for each one of the at least one beamformed signal, the respective virtual reference point, wherein the respective virtual reference point is offset from the position of the transmit point of the wireless communication network used for transmitting the at least one beamformed signal.

16. The method of claim 1, further comprising:
for each one of the at least one beamformed signal, determining the respective positioning information, wherein the respective positioning information is indicative of the respective virtual reference point.

17. A method for determining a position of a wireless communication device in a wireless communication network, the method comprising:
receiving at least one beamformed signal, wherein each one of the at least one beamformed signal is indicative of a respective positioning information.
receiving an indication indicating that the respective positioning information is indicative of a respective virtual reference point which is offset from a position of a transmit point of the wireless communication network used for transmitting the at least one beamformed signal, and
determining the position of the wireless communication device based on the positioning information and the indication.

18. The method of claim 17, further comprising:
receiving a message indicating that the respective positioning information of the at least one beamformed signal is indicative of the respective virtual reference point,
determining the position of the wireless communication device based on the indication that the at least one beamformed signal is indicative of the respective virtual reference point.

19. The method of claim 17, further comprising:
receiving a positioning information mapping indicative of a mapping of the respective positioning information to the respective virtual reference point for each of the at least one beamformed signal,
determining the position of the wireless communication device based on the positioning information mapping.

20-26. (canceled)

27. A network node in a wireless communication network, the network node comprising:
a transmitter configured to transmit at least one beamformed signal,
control circuitry configured to
determine, for each one of the at least one beamformed signal, a respective virtual reference point, wherein the respective virtual reference point is offset from a position of a transmit point of the wireless communication network used for transmitting the at least one beamformed signal, and
determine, for each one of the at least one beamformed signal, a respective positioning information, wherein the respective positioning information is indicative of the respective virtual reference point,
wherein the beamformed signal is suitable for enabling a positioning measurement of a wireless communication device.

28-30. (canceled)
